(19) United States
(12) Patent Application Publication
(10) Pub. No.: US 2010/0319235 A1
(43) Pub. Date: Dec. 23, 2010

(54) Remote fishing system

(76) Inventor: Miles R. Panaro, North Myrtle Beach, SC (US)

Correspondence Address: ROBERT M. DOWNEY, P.A., 6751 N. FEDERAL HWY., SUITE 300, BOCA RATON, FL, 33487, US

(21) Appl. No.: 12/802,927

(22) Filed: Jun. 17, 2010

Related U.S. Application Data
(60) Provisional application No. 61/269,050, filed on Jun. 18, 2009.

(51) Int. Cl. A01K 99/00; H04N 7/18

(52) U.S. Cl. 43/26.1; 348/157; 348/E07.091

(57) ABSTRACT

A platform (e.g. a floating vessel) on or adjacent to the surface of a body of water is equipped with one or more fishing devices (e.g. a fishing rod and reel) that feeds out and reels in fishing line, at least one video camera, a satellite transmission and receiving unit, a cellular telephone signal transmission and receiving unit and robotic controls for operating the fishing device. A user (i.e. an angler) at a remote personal computer communicates with the platform on the Internet via satellite and/or cellular wireless telephone signals and is able to operate the fishing device with the use of a keyboard, computer mouse and/or a fishing remote controller (i.e. a mock fishing rod and reel). The video camera allows the remotely located angler to view live video feeds of the fishing experience via the Internet, including the platform, fishing device and a fish caught on the line, on the angler's personal computer monitor. A real person (i.e. a mate) or a robot on the platform attaches artificial or real bait and hooks to the line, changes fishing line and terminal tackle when necessary, and releases any fish that are caught on the angler's line.

This non-provisional application is based on provisional patent application Ser. No. 61/269,050 filed on Jun. 18, 2009.

### BACKGROUND OF THE INVENTION

1. Field of the Invention

The present invention is directed to a remote fishing system and, more specifically, to a computer controlled fishing system for viewing and controlling a fishing rod and reel device at a location remote from the user.

2. Discussion of the Related Art

Sport fishing is enjoyed by people all over the world and is a significant component of the tourism industry. The excitement of hooking into and fighting a prize fish attracts both serious anglers and novice fishermen looking for adventure, often while on vacation to an exotic location. In fact, those who truly enjoy sport fishing will plan trips and travel to far away places to experience the thrill of reeling in a big game fish. Often this involves chartering a sport fishing boat with a captain and a mate who are familiar with the local waters and best techniques for catching various species of fish in those waters at any particular time of the year. The cost for chartering a sport fishing boat, in addition to airfare, lodging and meals can be considerably expensive. Nonetheless, serious sport fishermen spend tens of thousands of dollars each year travelling to distant locations to experience the thrill of sport fishing.

Unfortunately, many people who enjoy sport fishing are simply unable to travel to these distant locals due to the significant expense associated with air travel, lodging and chartering a fishing excursion. Other anglers who may be able to afford the journey simply do not have the time, perhaps due to hectic careers and family life. Accordingly, there remains a definite need for a remote fishing system that allows any person to enjoy a real life fishing experience, in real time (i.e. live), from the comfort of their home, office or other location. More particularly, there is an urgent need for a remote fishing system that allows a person to remotely control a fishing rod and reel on their personal computer, thereby allowing the person to view and control operation of the fishing rod while catching a fish at any far away location around the world.

### OBJECTS AND ADVANTAGES OF THE INVENTION

Considering the foregoing, it is a primary object of the present invention to provide a remote fishing system which allows users to control an actual fishing device (e.g. fishing rod and reel) to catch actual fish at a remote and distant location while the users remain at their home, office or places that may be far away from the fishing location.

It is a further object of the present invention to provide a remote fishing system, as described above, which uses a floating platform (i.e. a boat) on a body of water and which is equipped with at least one video camera, a satellite transmission and receiving unit, a cellular telephone signal transmission and receiving unit and robotic controls for operating the fishing device.

It is still a further object of the present invention to provide a remote fishing system, as described above, which is capable of using both manned and unmanned floating vessels.

It is still a further object of the present invention to provide a remote fishing system, as described above, which allows users to connect to the fishing vessel from their personal computers using an Internet connection and either satellite transmission or cellular signal transmission.

It is still a further object of the present invention to provide a remote fishing system, as described above, which allows users to connect to the system at any time of the day or night and fish from vessels located at far away exotic places around the world.

It is still a further object of the present invention to provide a remote fishing system, as described above, which allows multiple users connected to the same fishing vessel to communicate with each other and the mate and/or captain onboard in a social environment similar to that experienced on an actual fishing trip.

It is still a further object of the present invention to provide a remote fishing system, as described above, which allows users to connect to a fishing vessel and observe fishing, instead of participating, at a reduced cost or no cost.

It is still a further object of the present invention to provide a remote fishing system, as described above, which allows users who catch a fish to have that catch documented and photographed with their name, location of where the fish was caught, type of fish, size and weight of the caught fish along with any other pertinent information.

These and other objects and advantages of the present invention are more readily apparent with reference to the detailed description and accompanying drawings.

### SUMMARY OF THE INVENTION

The present invention is directed to a remote fishing device which allows users to connect to a floating platform (e.g. a vessel) on or below the surface of a body of water from their own personal computers to remotely participate in fishing activities. The fishing vessel is equipped with one or more fishing devices (e.g. a fishing rod and reel) that feed out and reel in fishing line attached to live or artificial bait. The platform may be manned or unmanned and is equipped with at least one video camera, a satellite transmission and receiving unit, a cellular telephone signal transmission and receiving unit and robotic controls for operating the fishing device.

A user (i.e. an angler) at a remote personal computer communicates with the platform on the Internet via a satellite and/or a wireless cellular connection and is able to operate the fishing device with the use of a keyboard, computer mouse or a unique controller similar to a computer game controller (e.g. a mock fishing rod and reel). The one or more video cameras enable the angler to view the fishing experience, including the platform, fishing device and a fish caught on the line, on the angler's personal computer monitor. Specifically, the video camera(s) views live images and transmits video image signals via the Internet connection on a live video feed. In a further embodiment, the video camera includes a microphone for capturing and transmitting audio signals via the Internet connection in conjunction with the live video feed.

A real person (i.e. a mate) or a robot on the platform attaches artificial or real bait and hooks to the line, changes fishing line and terminal tackle when necessary, and releases any fish that are caught on the angler's line. If a real person is present, such as a mate on the boat, he will personally address the user(s) and contribute to a social environment resembling that experienced during a typical fishing trip on a charter fishing boat. The user is also be able to communicate with other users on the same vessel.

Accordingly, an angler can log on to the Internet-based system using his/her personal computer at any location (home, office, etc.), pay a fee and enjoy an actual and real time fishing experience at various exotic locations around the world.

### BRIEF DESCRIPTION OF THE DRAWINGS

For a fuller understanding of the nature of the present invention, reference should be made to the following detailed description taken in conjunction with the accompanying drawings in which:

FIG. 1 is a side elevational view of the floating vessel shown transmitting a wireless signal through both satellite and cellular connections;

FIG. 2 is a schematic diagram of a personal computer with a monitor, keyboard, mouse and game controller device, and wherein the computer has an active Internet connection; and

FIG. 3 is a schematic diagram illustrating the wireless connection from the Internet provider to the floating vessel through both satellite and cellular connections.

Like reference numerals refer to like parts throughout the several views of the drawings.

### DETAILED DESCRIPTION OF THE PREFERRED EMBODIMENTS

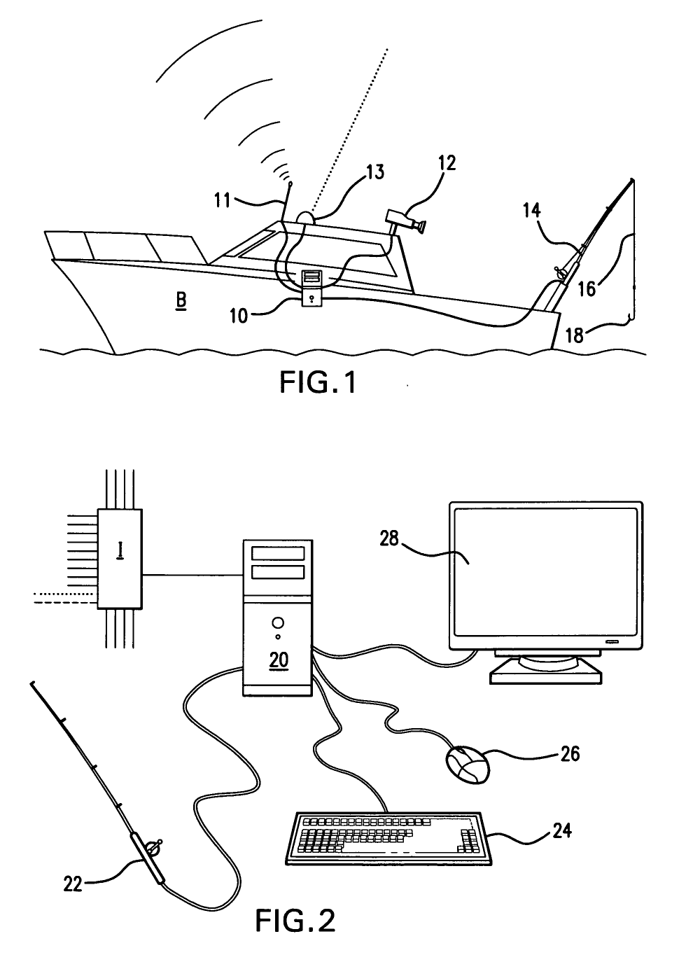

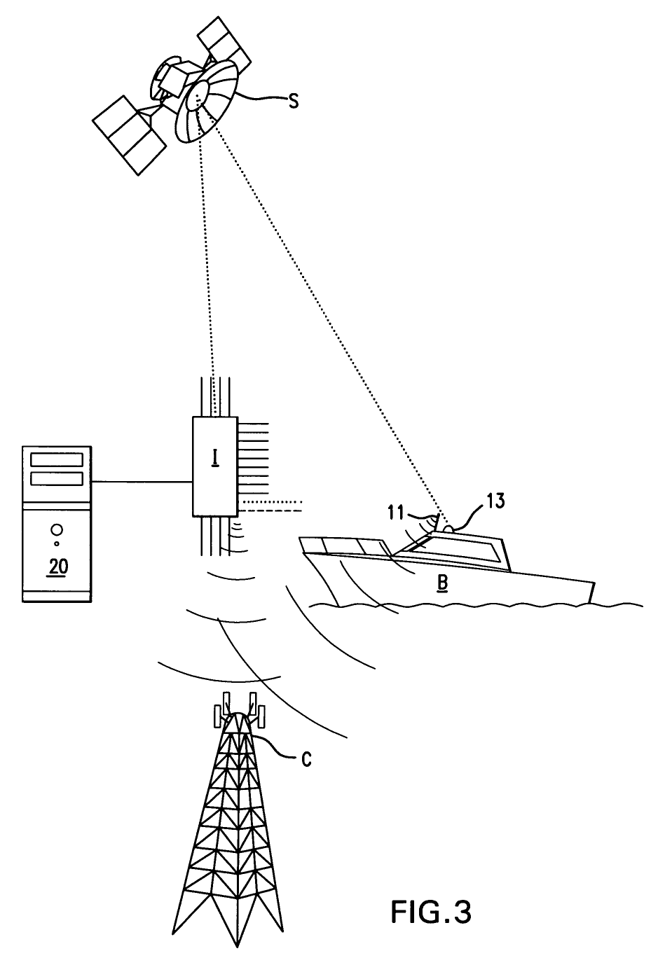

Referring initially to FIG. 1, the remote fishing system of the present invention is shown to include a floating vessel B that is equipped with at least one video camera 12, at least one robotically controlled fishing device 14, an onboard computer 10, a cellular transmitter/receiver 11 and a satellite transmitter/receiver 13. Most often the fishing device 14 will be a fishing rod and reel. This specific setup has a fishing line 16 and some combination of live bait or a lure 18 attached to a distal end of the fishing line and defining a fish attracting and hooking device. The at least one video camera 12, and at least one robotically controlled fishing device 14 connect to the computer 10 which controls signal delivery between these components (12, 14) and the satellite transmitter/receiver 13 and cellular transmitter/receiver 11.

The user is able to control the fishing device 14 through the use of his or her personal computer 20. The fishing device, as well as the surrounding waters, the boat, and an onboard mate may all be viewed through the computer monitor 28 with the use of the at least one video camera 12 onboard the vessel B. Specifically, one or more video cameras 12 view live images of the activity on the vessel B and deliver the images to the cellular transmitter/receiver 11 and/or the satellite transmitter/receiver for transmission over the Internet via a live video feed. The one or more video cameras 12 may further include at least one microphone for capturing sound, including voices of persons on the vessel B, which is then transmitted as audio signals in conjunction with the live video feed. Controlling of fishing device 14 is accomplished through either a combination of a standard computer mouse 26 and keyboard 24 or through a unique controller device 22 (e.g. a mock fishing rod and reel) which generate operational control signals that are sent to the onboard computer 10 via an Internet connection. The user's personal computer 20 is connected to an Internet service provider for direct Internet access I.

Connection of the user's computer 20 to the Internet is established in one or both of two ways: cellular telephone wireless signals and satellite. The Internet Provider I sends a signal to satellite S which reflects the signal to satellite receiver 13 onboard the fishing boat B. Similarly, the Internet Provider I sends a wireless signal to a cellular tower C which then sends the wireless signal to the boat B.

A real person onboard the fishing boat B (e.g., a mate and/or captain) can aid in fixing issues with the fishing devices, steering the vessel, changing bait and tackle, spotting fish and providing a fun, social environment which can provide a retreat for somebody unable and/or unwilling to travel far distances to experience a fishing trip. Cellular and satellite receivers 11 and 13, respectively, are capable of receiving multiple connections at once, allowing a number of users to fish and visually and audibly communicate among each other together on the same boat, thereby adding to the social feeling of a real fishing trip.

While the present invention has been shown in accordance with a preferred and practical embodiment, it is recognized that departures from the instant disclosure are fully contemplated within the spirit and scope of the present invention as set forth in the following claims.

What is claimed is:

1. A remote fishing system comprising:
a platform positionable at a body of water defining a fishing location;
a wireless signal transmitting and receiving device adapted for connecting to the Internet and for transmitting and receiving wireless signals for transmission via the Internet connection;
an onboard computer communicating with said wireless signal transmitting and receiving device;
at least one robotically controlled fishing device connected to said onboard computer for receiving operational control signals, and said at least one robotically controlled fishing device having a reeled fishing line with a distal end attached to a fish attracting and hooking device and said at least one robotically controlled fishing device being structured and disposed for feeding the fishing line out relative to the platform and for reeling the fishing line in order to pull the fish attracting and hooking device towards the platform in response to the operational control signals;
at least one video camera at said platform for viewing live moving images and for delivering the live moving images to said wireless signal transmitting and receiving device for transmission over the Internet via a live video feed;
a remote computer adapted to be connected to the Internet for communicating with said onboard computer;
a remote monitor connected to said remote computer for displaying the live moving images viewed by said at least one video camera at said platform; and
at least one controller connected to said remote computer for allowing a user at said remote computer to generate the operational control signals for transmission to said onboard computer via the Internet connection and for delivering the operational control signals to said at least one robotically controlled fishing device, thereby enabling the user to control said at least one robotically controlled fishing device while viewing said at least one robotically controlled fishing device and at least a portion of said platform and at least a portion of said body of water.

2. The remote fishing system as recited in claim 1 wherein said platform is a boat adapted to float and move on the body of water.

3. The remote fishing system as recited in claim 2 wherein said at least one robotically controlled fishing device is a fishing rod and reel.

4. The remote fishing system as recited in claim 1 wherein said at least one video camera includes a microphone for capturing sound on said platform for transmission as audio signals with the live moving images via the live video feed over the Internet.

5. The remote fishing system as recited in claim 1 wherein said at least one controller is a computer mouse.

6. The remote fishing system as recited in claim 1 wherein said at least one controller is a computer keyboard.

7. The remote fishing system as recited in claim 1 wherein said at least one controller is a video game controller structured and configured to resemble a fishing rod and reel.

8. The remote fishing system as recited in claim 1 wherein said wireless signal transmitting and receiving device is a cellular wireless signal transmitter and receiver device.

9. The remote fishing system as recited in claim 1 wherein said wireless signal transmitting and receiving device is a satellite transmitter and receiver.
